(19) United States
(12) Patent Application Publication
(10) Pub. No.: US 2025/0181997 A1
(43) Pub. Date: Jun. 5, 2025

(54) INFORMATION MANAGEMENT SYSTEM AND INFORMATION MANAGEMENT METHOD

(71) Applicant: Sharp NEC Display Solutions, Ltd., Tokyo (JP)

(72) Inventor: Yusuke OGIWARA, Tokyo (JP)

(21) Appl. No.: 19/049,181

(22) Filed: Feb. 10, 2025

Related U.S. Application Data
(63) Continuation of application No. PCT/JP2022/032762, filed on Aug. 31, 2022.

(51) Int. Cl. G06Q 10/02; G06Q 10/109

(52) U.S. Cl. CPC G06Q 10/02; G06Q 10/109

(57) ABSTRACT

An information management system manages provision information to be displayed on an information display terminal installed in an accommodation facility. The information management system includes a generation unit configured to generate accommodation-specific information that is unique information corresponding to the accommodation facility and an accommodation schedule of the accommodation facility, a conversion unit configured to convert location information including at least the accommodation-specific information into an information code, and a processing unit configured to allow access to the provision information from a first information terminal by receiving the accommodation-specific information from the first information terminal reading the information code displayed on the information display terminal after check-in of accommodation in the accommodation schedule of the accommodation facility.

### TECHNICAL FIELD

The present invention relates to an information management system and an information management method.

### BACKGROUND ART

It is important for guests to know how to use information about equipment of accommodation facilities and peripheral facilities to improve the accommodation experience in a residential accommodation business. By installing an information display terminal in an accommodation facility to inform guests of how to use information about equipment of accommodation facilities and peripheral facilities, it is possible to provide useful information to guests during a period of stay.

In addition, if guests can know how to use information about equipment of accommodation facilities and peripheral facilities before staying, there is an advantage that they can plan their trip in advance.

A system for authenticating the visit of a portable terminal owner using a customer's portable terminal is known (see, for example, Patent Document 1).

### CITATION LIST

### Patent Document

### Patent Document 1

Japanese Unexamined Patent Application, First Publication No. 2008-020991

### SUMMARY OF INVENTION

### Technical Problem

However, because other people as well as the person himself or herself stay at an accommodation facility, it is necessary to authenticate the person himself or herself during information provision and personal information of a guest is required at that time. This personal information is required to be handled carefully so that the personal information is not leaked and unnecessary acquisition should be avoided.

An objective of the present invention is to provide an information management system and an information management method capable of minimizing confirmation for determining whether or not information can be provided in accordance with an information provision timing so that the information can be provided within an appropriate range.

### Solution to Problem

(1) According to an aspect of the present invention, there is provided an information management system for managing provision information to be displayed on an information display terminal installed in an accommodation facility, the information management system including: a generation unit configured to generate accommodation-specific information that is unique information corresponding to the accommodation facility and an accommodation schedule of the accommodation facility; a conversion unit configured to convert location information including at least the accommodation-specific information into an information code; and a processing unit configured to allow a first information terminal to have an access to the provision information by receiving the accommodation-specific information from the first information terminal reading the information code displayed on the information display terminal after check-in of accommodation in the accommodation schedule of the accommodation facility.
(2) According to an aspect of the present invention, in the information management system according to the above-described (1), the location information further includes information for identifying a location of the provision information, and the processing unit allows the first information terminal to have the access to the provision information by receiving the accommodation-specific information from the first information terminal when the first information terminal reading the information code has accessed the provision information.
(3) According to an aspect of the present invention, in the information management system according to the above-described (1) or (2), the processing unit allows a second information terminal to have the access to the provision information even if the accommodation-specific information is not received from the first information terminal by receiving reservation-specific information, which is information generated in accordance with an accommodation reservation in an accommodation schedule of the accommodation facility, from the second information terminal.
(4) According to an aspect of the present invention, in the information management system according to the above-described (3), the information display terminal displays the accommodation-specific information for the first time after the check-in and the reservation-specific information is generated before the check-in.
(5) According to an aspect of the present invention, in the information management system according to the above-described (3) or (4), the first information terminal is the same as the second information terminal.
(6) According to an aspect of the present invention, in the information management system according to any one of the above-described (3) to (5), provision information allowed to be accessed on the basis of the accommodation-specific information is different from provision information allowed to be accessed on the basis of the reservation-specific information.
(7) According to an aspect of the present invention, in the information management system according to any one of the above-described (1) to (6), the generation unit further generates accommodation-specific information corresponding to a guest.
(8) According to an aspect of the present invention, in the information management system according to any one of the above-described (1) to (7), the generation unit further generates accommodation-specific information corresponding to identification information of a guest room where a guest stays.
(9) According to an aspect of the present invention, there is provided an information management system for managing provision information to be displayed on an information display terminal installed in an accommodation facility, the information management system including: a processing unit configured to allow a first information terminal to have an access to the provision information by receiving reservation-specific information that is information generated in accordance with an accommodation reservation of the accommodation facility from the first information terminal; a generation unit configured to generate accommodation-specific information that is unique information corresponding to the accommodation facility and an accommodation schedule of the accommodation facility; and a conversion unit configured to convert information including at least the accommodation-specific information into an information code, wherein the processing unit allows a second information terminal to have an access to the provision information even if the reservation-specific information is not received from the first information terminal by receiving the accommodation-specific information from the second information terminal reading the information code displayed on the information display terminal after check-in of a guest for the accommodation facility.
(10) According to an aspect of the present invention, in the information management system according to the above-described (9), the information display terminal displays the accommodation-specific information for the first time after the check-in and the reservation-specific information is generated before the check-in.
(11) According to an aspect of the present invention, in the information management system according to the above-described (9) or (10), the first information terminal is the same as the second information terminal.
(12) According to an aspect of the present invention, there is provided an information management method of managing provision information to be displayed on an information display terminal installed in an accommodation facility, the information management method including: generating accommodation-specific information that is unique information corresponding to the accommodation facility and an accommodation schedule of the accommodation facility; converting location information including at least the accommodation-specific information into an information code; and allowing a first information terminal to have an access to the provision information by receiving the accommodation-specific information from the first information terminal reading the information code displayed on the information display terminal after check-in of accommodation in the accommodation schedule of the accommodation facility.
(13) According to an aspect of the present invention, there is provided an information management method of managing provision information to be displayed on an information display terminal installed in an accommodation facility, the information management method including: allowing a first information terminal to have an access to the provision information by receiving reservation-specific information that is information generated in accordance with an accommodation reservation of the accommodation facility from the first information terminal; generating accommodation-specific information that is unique information corresponding to the accommodation facility and an accommodation schedule of the accommodation facility; converting information including at least the accommodation-specific information into an information code; and allowing a second information terminal even to have an access to the provision information even if the reservation-specific information is not received from the second information terminal by receiving the accommodation-specific information from the second information terminal reading the information code displayed on the information display terminal after check-in of a guest for the accommodation facility.

### Advantageous Effects of Invention

According to the present invention, it is possible to provide an information management system and an information management method capable of minimizing confirmation for determining whether or not information can be provided in accordance with an information provision timing so that the information can be provided within an appropriate range.

### BRIEF DESCRIPTION OF DRAWINGS

FIG. 1 is a diagram showing an example of a configuration of an information management system according to an embodiment of the present invention.

FIG. 2 is a diagram showing details of an information management server, an information terminal, an accommodation reservation system, and an information display terminal according to the present embodiment.

FIG. 3 is a diagram showing Example 1 of an operation of the information management system according to the present embodiment.

FIG. 4 is a diagram showing Example 2 of an operation of the information management system according to the present embodiment.

### DESCRIPTION OF EMBODIMENTS

Next, an information management system and an information management method of the present embodiment will be described with reference to the drawings. The embodiments to be described below are only examples and embodiments to which the present invention applies are not limited to the following embodiments.

In addition, in all the drawings for describing the embodiments, components having the same function are denoted by the same reference signs and redundant descriptions thereof will be omitted.

Moreover, in the present application, the term “based on XX” indicates “based on at least XX” and includes cases based on another element in addition to “XX.” In addition, the term “based on XX” is not limited to cases in which “XX” is directly used, and also includes cases based on “XX” on which calculation or processing has been performed. “XX” may be any element (for example, any information).

### EMBODIMENT

### Information Management System

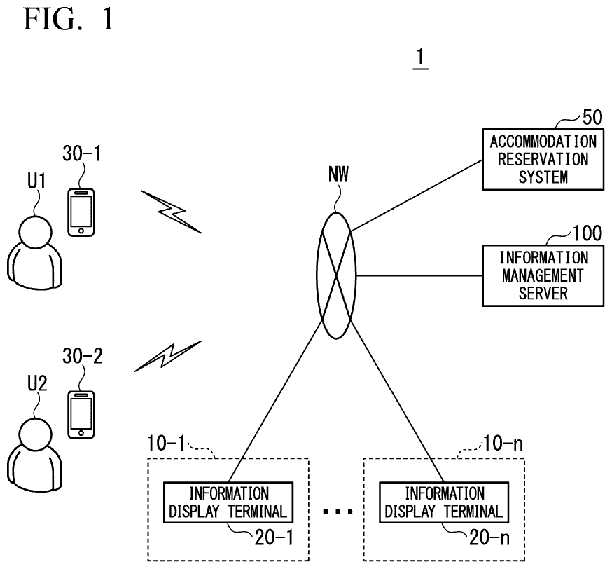

FIG. 1 is a diagram showing an example of a configuration of an information management system according to an embodiment of the present invention. In FIG. 1, the information management system 1 includes an information management server 100. In FIG. 1, information display terminals 20-1 to 20-n (n is an integer for which n>0), a person (customer) who makes an accommodation reservation such as a user U1 or a user U2, an information terminal 30-1 used by the user U1, an information terminal 30-2 used by the user U2, and an accommodation reservation system 50 are shown in addition to the information management server 100.

The information display terminals 20-1 to 20-n are installed in the accommodation facilities 10-1 to 10-n, respectively. For example, the accommodation facilities 10-1 to 10-n are private accommodation facilities. The private accommodation facility provides accommodation services to travelers and the like by utilizing all or part of a house (a detached house, an apartment house such as a condominium, or the like).

The information management server 100, the information display terminals 20-1 to 20-n, the information terminal 30-1, the information terminal 30-2, and the accommodation reservation system 50 communicate with each other via a network NW. The network NW includes, for example, the Internet, a wide area network (WAN), a local area network (LAN), a provider device, a radio base station, and the like.

The user U1 accesses the accommodation reservation system 50 using the information terminal 30-1 and makes an accommodation reservation. After the accommodation reservation is completed, the accommodation reservation system 50 creates reservation information for a guest and stores the created reservation information for the guest. The accommodation reservation system 50 creates reservation-specific information including information for identifying an accommodation facility, information for identifying a name of a guest, information for identifying an accommodation schedule, and the like. The accommodation reservation system 50 transmits the created reservation-specific information to the information management server 100 and the information terminal 30-1.

The information management server 100 receives the reservation-specific information transmitted by the accommodation reservation system 50 and stores the received reservation-specific information in the storage unit.

The information terminal 30-1 receives the reservation-specific information transmitted by the accommodation reservation system 50 and stores the received reservation-specific information.

A situation occurring after the user U1 makes an accommodation reservation and before the user U1 checks in to an accommodation facility will be described.

After making the accommodation reservation and before checking in to the accommodation facility, the user U1 uses the information terminal 30-1 to access the information management server 100 when the user U1 wants to know information of equipment of an accommodation facility, an accommodation location, and the like (hereinafter referred to as “first provision information”). The information terminal 30-1 creates a first access request including reservation-specific information and transmits the created first access request to the information management server 100.

The information management server 100 receives the first access request and acquires reservation-specific information included in the received first access request. The information management server 100 determines whether or not the acquired reservation-specific information is stored in the storage unit. When the acquired reservation-specific information is stored in the storage unit, the information management server 100 allows an access request from the information terminal 30-1. When the access request from the information terminal 30-1 is allowed, the information management server 100 creates a first access response including first provision information to be provided to the user U1 and transmits the created first access response to the information terminal 30-1.

The information terminal 30-1 receives the first access response transmitted by the information management server 100 and displays the first provision information provided to the user U1 included in the received access response.

On the other hand, when the acquired reservation-specific information is not stored in the storage unit, the information management server 100 does not allow an access request from the information terminal 30-1. When the access request from the information terminal 30-1 is not allowed, the information management server 100 creates a first access response including information indicating that the access request is not allowed and transmits the created first access response to the information terminal 30-1.

The information terminal 30-1 receives the first access response transmitted by the information management server 100 and displays information indicating that the access request is not allowed included in the received first access response.

A situation occurring after the user U1 checks in to the accommodation facility will be described. When the user U1 checks in to the accommodation facility, check-in information is transmitted from the accommodation facility. The information management server 100 receives the check-in information transmitted from the accommodation facility and sets corresponding information within the reservation information of the guest stored in the storage unit 109 to a checked-in state on the basis of the received check-in information.

The information management server 100 generates accommodation-specific information. The accommodation-specific information is unique information corresponding to an accommodation facility and an accommodation schedule of the accommodation facility. The information management server 100 causes the storage unit to store the generated accommodation-specific information. The information management server 100 converts location information including the generated accommodation-specific information into an information code (two-dimensional information code) such as a quick response (QR) code (registered trademark). The information management server 100 outputs the created information code to the information display terminal 20.

The information display terminal 20 displays the information code from the information management server 100 on the display unit.

After checking in to the accommodation facility, the user U1 uses the information terminal 30-1 to access the information management server 100 when the user U1 wants to know how to use the accommodation facility, how to contact the accommodation facility when there is a deficiency in the accommodation facility, and the like (hereinafter referred to as “second provision information”). Specifically, the information terminal 30-1 reads the information code displayed on the display unit of the information display terminal 20 and acquires location information including accommodation-specific information. The information terminal 30-1 creates a second access request including the accommodation-specific information included in the acquired location information and transmits the created second access request to the information management server 100.

The information management server 100 receives the second access request and acquires the accommodation-specific information included in the received second access request. The information management server 100 determines whether or not the acquired accommodation-specific information is stored in the storage unit. When the acquired accommodation-specific information is stored in the storage unit, the information management server 100 allows the access request from the information terminal 30-1. When the access request from the information terminal 30-1 is allowed, the information management server 100 creates a second access response including second provision information to be provided to the user U1 and transmits the created second access response to the information terminal 30-1.

The information terminal 30-1 receives the second access response transmitted by the information management server 100 and displays the second provision information provided to the user U1 included in the received access response.

On the other hand, when the acquired accommodation-specific information is not stored in the storage unit, the information management server 100 does not allow the access request from the information terminal 30-1. When the access request from the information terminal 30-1 is not allowed, the information management server 100 creates a second access response including information indicating that the access request is not allowed and transmits the created second access response to the information terminal 30-1.

The information terminal 30-1 receives the second access response transmitted by the information management server 100 and displays information indicating that the access request is not allowed included in the received second access response.

A similar process is performed even when the user U2 makes an accommodation reservation using the information terminal 30-2 and acquires first provision information and second provision information from the information management server 100.

Hereinafter, either one of the user U1 and the user U2 will be referred to as a user U and either one of the information terminal 30-1 and the information terminal 30-2 will be referred to as an information terminal 30.

Hereinafter, the information management server 100, the information terminal 30, the accommodation reservation system 50, and the information display terminal 20 will be described sequentially.

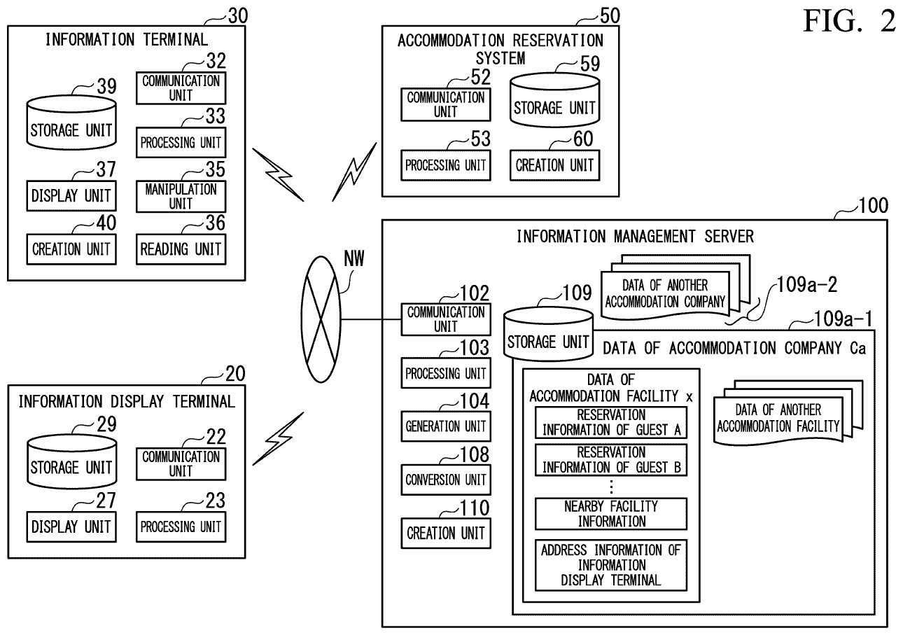

FIG. 2 is a diagram showing details of the information management server, the information terminal, the accommodation reservation system, and the information display terminal according to the present embodiment.

### Information Management Server 100

The information management server 100 is implemented by a device such as a personal computer, a server, a smartphone, a tablet computer, or an industrial computer. The information management server 100 may be a cloud server.

The information management server 100 includes, for example, a communication unit 102, a processing unit 103, a generation unit 104, a conversion unit 108, a storage unit 109, and a creation unit 110.

The communication unit 102 is implemented by a communication module. The communication unit 102 communicates with an external communication device via a network NW. The communication unit 102 may perform communication in a communication method based on, for example, a wired LAN or the like. Moreover, the communication unit 102 may perform communication in a wireless communication method based on, for example, a wireless LAN, Bluetooth (registered trademark), LTE (registered trademark), or the like.

The storage unit 109 is implemented by a hard disk drive (HDD), a flash memory, a random-access memory (RAM), a read-only memory (ROM), or the like. The storage unit 109 stores one or more data items of an accommodation company.

FIG. 2 shows data 109a-1 of an accommodation company Ca and data 109a-2 of other accommodation companies as examples of data of the accommodation company. The data 109a-1 of the accommodation company Ca includes one or more data items of accommodation facilities. In FIG. 2, data of an accommodation facility x and data of other accommodation facilities are shown as examples of data of an accommodation facility. The data of the accommodation facility x includes reservation information of guest A, reservation information of guest B, . . . , peripheral facility information, address information of an information display terminal, and the like. The reservation information of guest A includes information for identifying guest A, information for identifying an accommodation schedule, and the like. The address information of the information display terminal is address information of an information display terminal provided in the accommodation facility x. A plurality of information display terminals may be provided in the accommodation facility x.

The communication unit 102 receives a reservation-specific information notification transmitted by the accommodation reservation system 50.

The processing unit 103 acquires the reservation-specific information notification from the communication unit 102 and causes the storage unit 109 to store reservation-specific information included in the acquired reservation-specific information notification.

The communication unit 102 receives a first access request transmitted by the information terminal 30.

The processing unit 103 acquires the first access request from the communication unit 102 and acquires reservation-specific information of the user U included in the acquired first access request. The processing unit 103 determines whether or not the acquired reservation-specific information is stored in the storage unit 109. When the reservation-specific information of the user U is stored in the storage unit 109, the processing unit 103 allows access from the information terminal 30.

When the processing unit 103 has allowed access from the information terminal 30, the creation unit 110 creates a first access response including first provision information to be provided to the user U. In addition to information of equipment of an accommodation facility, an accommodation location, and the like, the first provision information includes information about the preparation for accommodation such as “Please bring a warm jacket because it will be cold at night” and meaningful information because it is before accommodation such as information of services provided by the accommodation facility. Moreover, it may be possible to make a reservation in advance from information of services. The creation unit 110 outputs the created first access response to the communication unit 102. The communication unit 102 transmits the first access response from the creation unit 110 to the information terminal 30.

When the reservation-specific information of the user U is not stored in the storage unit 109, the processing unit 103 does not allow access from the information terminal 30.

When the processing unit 103 does not allow access from the information terminal 30, the creation unit 110 creates a first access response including information indicating that access is not possible. The creation unit 110 outputs the created first access response to the communication unit 102. The communication unit 102 transmits the first access response from the creation unit 110 to the information terminal 30.

The communication unit 102 receives check-in information transmitted from the accommodation facility. The check-in information includes information for identifying an accommodation facility, information for identifying a guest, information for identifying an accommodation schedule, and the like.

The processing unit 103 performs a check-in process. In the check-in process, the processing unit 103 acquires check-in information from the communication unit 102, and sets the corresponding information within the reservation information of the guest stored in the storage unit 109 to a checked-in state on the basis of the acquired check-in information. The processing unit 103 acquires address information of the information display terminal included in the data of the accommodation facility including the reservation information of the guest who has checked in. The processing unit 103 outputs the acquired address information of the information display terminal to the creation unit 110.

The generation unit 104 acquires check-in information from the communication unit 102 and acquires information for identifying an accommodation facility and information for identifying an accommodation schedule included in the acquired check-in information. The generation unit 104 generates accommodation-specific information that is unique information corresponding to the acquired information for identifying the accommodation facility and the acquired information for identifying the accommodation schedule. For example, the generation unit 104 may generate a character string using the information for identifying the accommodation facility and the information for identifying the accommodation schedule and designate the generated character string as the accommodation-specific information. The generation unit 104 causes the storage unit 109 to store the generated accommodation-specific information.

The conversion unit 108 acquires the accommodation-specific information from the generation unit 104 and converts the location information including the acquired accommodation-specific information into information code information.

The creation unit 110 acquires the address information of the information display terminal output by the processing unit 103. The creation unit 110 acquires the information code information from the conversion unit 108 and creates an information code notification which includes the acquired information code information and in which the acquired address information of the information display terminal is designated as a destination. The creation unit 110 outputs the created information code notification to the communication unit 102. The communication unit 102 transmits the information code notification output by the processing unit 103 to the information display terminal 20.

The communication unit 102 receives a second access request transmitted by the information terminal 30.

The processing unit 103 acquires the second access request from the communication unit 102 and acquires accommodation-specific information included in the acquired access request. The processing unit 103 determines whether or not the acquired accommodation-specific information is stored in the storage unit 109.

When the accommodation-specific information is stored in the storage unit 109, the processing unit 103 allows access from the information terminal 30. When the processing unit 103 allows access from the information terminal 30, the creation unit 110 creates a second access response including second provision information to be provided to the user U. In addition to how to use the accommodation facility, how to contact the accommodation facility when there is a deficiency in the accommodation facility, and the like, the second provision information includes information of restaurants around the accommodation facility, information of local activities such as amusement parks, information of services provided by the accommodation facility, and the like. Moreover, it may be possible to make a reservation from the service information.

The creation unit 110 outputs the created second access response to the communication unit 102. The communication unit 102 transmits the second access response from the creation unit 110 to the information terminal 30.

The processing unit 103 does not allow access from the information terminal 30 when the accommodation-specific information of the user U is not stored in the storage unit 109. When the processing unit 103 does not allow access from the information terminal 30, the creation unit 110 creates a second access response including information indicating that access is not possible. The creation unit 110 outputs the created second access response to the communication unit 102. The communication unit 102 transmits the second access response from the creation unit 110 to the information terminal 30.

The processing unit 103, the generation unit 104, the conversion unit 108, and the creation unit 110 are implemented by, for example, a hardware processor such as a central processing unit (CPU) executing a computer program (software) stored in the storage unit 109.

Moreover, some or all of these functional units may be implemented by hardware (including a circuit unit; circuitry) such as a large-scale integration (LSI) circuit, an application-specific integrated circuit (ASIC), a field-programmable gate array (FPGA), or a graphics processing unit (GPU) or may be implemented by software and hardware in cooperation. The program may be pre-stored in a storage device such as an HDD or a flash memory or may be stored in a removable storage medium such as a DVD- or CD-ROM and installed when the storage medium is mounted in a drive device.

### Information Terminal 30

The information terminal 30 is implemented as a smartphone, a portable terminal, a personal computer, a tablet terminal device, a wristwatch-type terminal device, or another information processing device.

The information terminal 30 includes, for example, a communication unit 32, a processing unit 33, a manipulation unit 35, a reading unit 36, a display unit 37, a storage unit 39, and a creation unit 40.

The communication unit 32 is implemented by a communication module. The communication unit 32 communicates with another device such as the information management server 100 via the network NW. The communication unit 32 may perform communication, for example, in a wireless communication method. Moreover, the communication unit 32 may perform communication in a communication method based on, for example, a wired LAN or the like.

The display unit 37 displays a screen output by the processing unit 33.

The manipulation unit 35, for example, includes a touch panel or the like, detects a touch manipulation on the screen displayed on the display unit 37, and outputs a touch manipulation detection result to the creation unit 40.

The storage unit 39, for example, is implemented by a RAM, a ROM, a flash memory, a hybrid storage device in which two or more thereof are combined, or the like.

The reading unit 36 generates image data by reading an image to be read. The reading unit 36 includes a scanner device or the like that converts an image into an electrical signal with an image sensor such as a charge-coupled device (CCD) or a contact image sensor (CIS) and generates digital data by quantizing and encoding the electrical signal.

The communication unit 32 receives a reservation-specific information notification transmitted by the accommodation reservation system 50.

The processing unit 33 acquires a reservation-specific information notification from the communication unit 32 and causes the storage unit 39 to store the reservation-specific information included in the acquired reservation-specific information notification.

The manipulation unit 35 detects a manipulation in which the user U accesses the information management server 100 after making a reservation for the accommodation facility and before checking in to the accommodation facility.

The creation unit 40 acquires manipulation information detected by the manipulation unit 35 and acquires reservation-specific information from the storage unit 39 on the basis of the acquired manipulation information. The creation unit 40 creates a first access request including the acquired reservation-specific information. The creation unit 40 outputs the created first access request to the communication unit 32. The communication unit 32 transmits the first access request acquired from the creation unit 40 to the information management server 100.

The communication unit 32 receives a first access response transmitted by the information management server 100. The processing unit 33 acquires the first access response from the communication unit 32. The processing unit 33 processes first provision information to be provided to the user U or information indicating that access is not possible included in the acquired first access response and causes the display unit 37 to display the processed information.

After checking in to the accommodation facility, the user U performs a manipulation of reading an information code displayed on the display unit 27 of the information display terminal 20 with respect to the information terminal 30. The reading unit 36 reads the information code on the basis of a manipulation of the user U and acquires location information including accommodation-specific information. The reading unit 36 causes the storage unit 39 to store the accommodation-specific information included in the acquired location information.

The manipulation unit 35 detects a manipulation in which the user U accesses the information management server 100 after checking in to the accommodation facility. The creation unit 40 acquires manipulation information detected by the manipulation unit 35 and acquires accommodation-specific information from the storage unit 39 on the basis of the acquired manipulation information. The creation unit 40 creates a second access request including the acquired accommodation-specific information. The creation unit 40 outputs the created second access request to the communication unit 32. The communication unit 32 transmits the second access request acquired from the creation unit 40 to the information management server 100.

The communication unit 32 receives the second access response transmitted by the information management server 100. The processing unit 33 acquires the second access response from the communication unit 32. The processing unit 33 processes the second provision information to be provided to the user U or the information indicating that access is not possible included in the acquired second access response and causes the display unit 37 to display the processed information.

All or some of the processing unit 33, the manipulation unit 35, the reading unit 36, and the creation unit 40 are, for example, functional units (hereinafter referred to as software function units) implemented by, for example, a processor such as a CPU executing a program stored in the storage unit 39.

Moreover, some or all of these functional units may be implemented by hardware (including a circuit unit; circuitry) such as an LSI circuit, an ASIC, an FPGA, or a GPU or may be implemented by software and hardware in cooperation. The program may be pre-stored in a storage device such as an HDD or a flash memory or may be stored in a removable storage medium such as a DVD- or CD-ROM and installed when the storage medium is mounted in a drive device.

### Accommodation Reservation System 50

The accommodation reservation system 50 is implemented by a device such as a personal computer, a server, a smartphone, a tablet computer, or an industrial computer. The accommodation reservation system 50 may be a cloud server.

The accommodation reservation system 50 includes, for example, a communication unit 52, a processing unit 53, a storage unit 59, and a creation unit 60.

The communication unit 52 is implemented by a communication module. The communication unit 52 communicates with an external communication device via the network NW. The communication unit 52 may perform communication in a communication method based on, for example, a wired LAN or the like. Moreover, the communication unit 52 may perform communication in a wireless communication method based on, for example, a wireless LAN, Bluetooth (registered trademark), LTE (registered trademark), or the like.

The storage unit 59 is implemented by an HDD, a flash memory, a RAM, a ROM, or the like. The storage unit 59 stores a reservation-specific information DB. The reservation-specific information DB includes one or more reservation-specific information items.

The communication unit 52 receives a reservation request transmitted by the information terminal 30. The reservation request includes information for identifying a guest, information for identifying an accommodation facility, information for identifying an accommodation schedule, and the like. For example, the reservation request is transmitted from the information terminal 30 when the accommodation reservation system 50 presents information for identifying an accommodation facility for which a reservation is possible and a schedule in which a reservation for the accommodation facility is possible to the information terminal 30.

The processing unit 53 acquires reservation information from the communication unit 52 and performs an accommodation reservation process on the basis of the acquired reservation information. In the accommodation reservation process, the processing unit 53 causes the reservation-specific information DB to store reservation-specific information associated with information for identifying an accommodation facility, information for identifying a name of a guest, information for identifying a date of accommodation, and the like.

The creation unit 60 acquires reservation-specific information from the processing unit 53. The creation unit 60 creates a reservation-specific information notification which includes the acquired reservation-specific information and in which the address of the information terminal 30 and the address of the information management server 100 are designated as a destination. The creation unit 60 outputs the created reservation-specific information notification to the communication unit 52. The communication unit 52 transmits a reservation-specific information notification from the creation unit 60 to the information terminal 30 and the information management server 100.

The communication unit 52 receives the check-in information transmitted from the accommodation facility. The processing unit 53 acquires the check-in information from the communication unit 52 and sets the corresponding information within the reservation-specific information stored in the storage unit 59 to a checked-in state on the basis of the acquired check-in information.

The processing unit 53 and the creation unit 60 are implemented by, for example, a hardware processor such as a CPU executing a computer program (software) stored in the storage unit 59.

Moreover, some or all of these functional units may be implemented by hardware (including a circuit unit; circuitry) such as an LSI circuit, an ASIC, an FPGA, or a GPU or may be implemented by software and hardware in cooperation. The program may be pre-stored in a storage device such as an HDD or a flash memory or may be stored in a removable storage medium such as a DVD- or CD-ROM and installed when the storage medium is mounted in a drive device.

### Information Display Terminal 20

The information display terminal 20 is implemented as a smartphone, a portable terminal, a personal computer, a tablet terminal device, or another information processing device.

The information display terminal 20 includes, for example, a communication unit 22, a processing unit 23, a display unit 27, and a storage unit 39.

The communication unit 22 is implemented by a communication module. The communication unit 22 communicates with another device such as the information management server 100 via the network NW. The communication unit 22, for example, may perform communication, for example, in a wireless communication method. Moreover, the communication unit 22 may perform communication in a communication method based on, for example, a wired LAN or the like.

The display unit 27 displays a screen output by the processing unit 23.

The storage unit 29, for example, is implemented by a RAM, a ROM, a flash memory, a hybrid storage device in which two or more thereof are combined, or the like.

The communication unit 22 receives the information code notification transmitted by the information management server 100.

The processing unit 23 acquires the information code notification from the communication unit 22 and acquires information code information included in the acquired information code notification. The processing unit 23 causes the display unit 27 to display the information code by processing the acquired information code information.

All or part of the processing unit 23 is, for example, a functional unit (hereinafter referred to as a software function unit) implemented by, for example, a processor such as a CPU executing a program stored in the storage unit 29.

Moreover, some or all of these functional units may be implemented by hardware (including a circuit unit; circuitry) such as an LSI circuit, an ASIC, an FPGA, or a GPU or may be implemented by software and hardware in cooperation. The program may be pre-stored in a storage device such as an HDD or a flash memory or may be stored in a removable storage medium such as a DVD- or CD-ROM and installed when the storage medium is mounted in a drive device.

### Operation of Information Management System 1

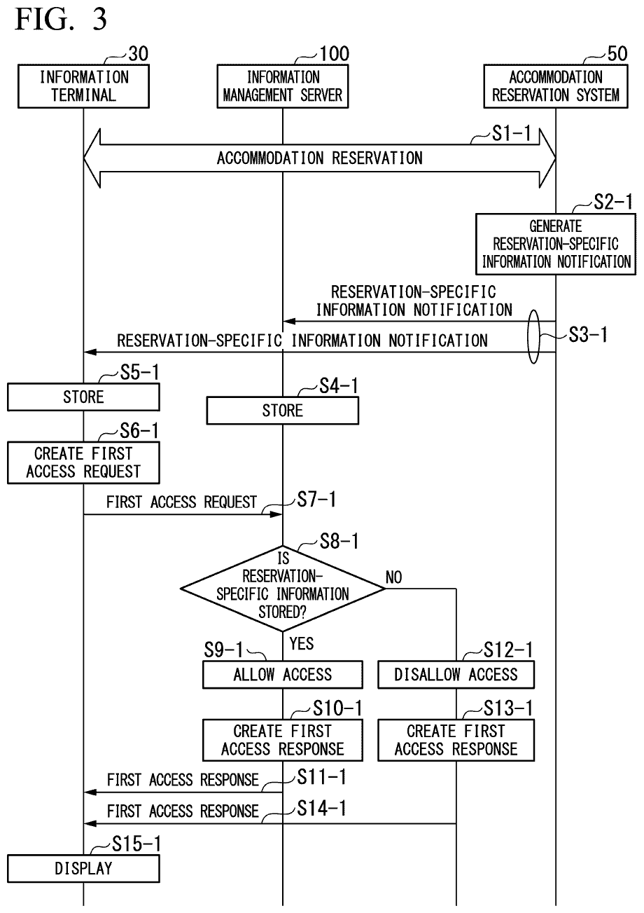

FIG. 3 is a diagram showing Example 1 of an operation of the information management system according to the present embodiment. A process in which the user U acquires information from the information management server 100 after the user U makes a reservation and before the user U checks in to the accommodation facility will be described with reference to FIG. 3.

### Step S1-1

An accommodation reservation process is performed between the information terminal 30 and the information management server 100.

### Step S2-1

In the accommodation reservation system 50, the creation unit 60 acquires reservation-specific information from the processing unit 53. The creation unit 60 creates a reservation-specific information notification which includes the acquired reservation-specific information and in which the address of the information terminal 30 and the address of the information management server 100 are designated as a destination.

### (Step S3-1)

In the accommodation reservation system 50, the creation unit 60 outputs the created reservation-specific information notification to the communication unit 52. The communication unit 52 transmits the reservation-specific information notification from the creation unit 60 to the information terminal 30 and the information management server 100.

### (Step S4-1)

In the information management server 100, the communication unit 102 receives the reservation-specific information notification transmitted by the accommodation reservation system 50. The processing unit 103 acquires the reservation-specific information notification from the communication unit 102 and causes the storage unit 109 to store the reservation-specific information included in the acquired reservation-specific information notification.

### (Step S5-1)

In the information terminal 30, the communication unit 32 receives the reservation-specific information notification transmitted by the accommodation reservation system 50. The processing unit 33 acquires the reservation-specific information notification from the communication unit 32 and causes the storage unit 39 to store the reservation-specific information included in the acquired reservation-specific information notification.

### (Step S6-1)

In the information terminal 30, the manipulation unit 35 detects a manipulation in which the user U accesses the information management server 100 before checking in to the accommodation facility. The creation unit 40 acquires manipulation information detected by the manipulation unit 35 and acquires the reservation-specific information from the storage unit 39 on the basis of the acquired manipulation information. The creation unit 40 creates a first access request including the acquired reservation-specific information.

### (Step S7-1)

In the information terminal 30, the creation unit 40 outputs the created first access request to the communication unit 32. The communication unit 32 transmits the first access request acquired from the creation unit 40 to the information management server 100.

### (Step S8-1)

In the information management server 100, the communication unit 102 receives the first access request transmitted by the information terminal 30. The processing unit 103 acquires the first access request from the communication unit 102 and acquires reservation-specific information included in the acquired first access request. The processing unit 103 determines whether or not the reservation-specific information acquired from the first access request is stored in the storage unit 109.

### (Step S9-1)

In the information management server 100, the processing unit 103 allows access from the information terminal 30 when the reservation-specific information acquired from the first access request is stored in the storage unit 109.

### (Step S10-1)

In the information management server 100, the creation unit 110 creates a first access response including first provision information to be provided to the user U when the processing unit 103 allows access from the information terminal 30.

### (Step S11-1)

In the information management server 100, the creation unit 110 outputs the created first access response to the communication unit 102. The communication unit 102 transmits the first access response from the creation unit 110 to the information terminal 30.

### (Step S12-1)

In the information management server 100, the processing unit 103 does not allow access from the information terminal 30 when the reservation-specific information acquired from the first access request is not stored in the storage unit 109.

### (Step S13-1)

In the information management server 100, the creation unit 110 creates a first access response including information indicating that access is not possible when the processing unit 103 does not allow access from the information terminal 30.

### (Step S14-1)

In the information management server 100, the creation unit 110 outputs the created first access response to the communication unit 102. The communication unit 102 transmits the first access response from the creation unit 110 to the information terminal 30.

### (Step S15-1)

In the information terminal 30, the communication unit 32 receives the first access response transmitted by the information management server 100. The processing unit 33 acquires the first access response from the communication unit 32. The processing unit 33 processes first provision information to be provided to the user U or information indicating that access is not possible included in the acquired first access response and causes the display unit 37 to display the processed information.

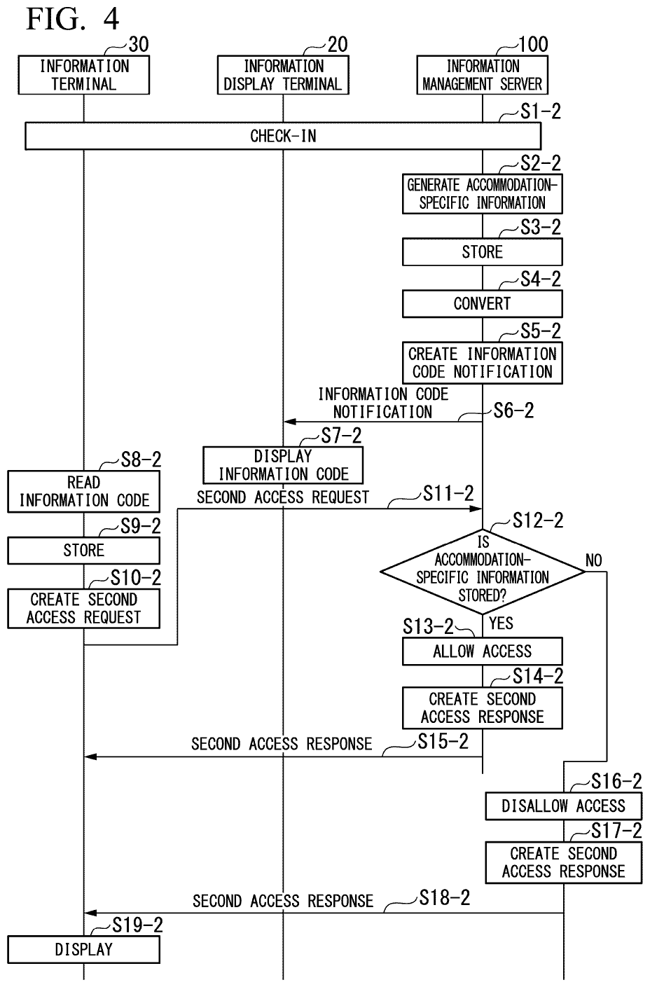

FIG. 4 is a diagram showing Example 2 of the operation of the information management system according to the present embodiment. A process in which the user U acquires information from the information management server 100 after checking in to the accommodation facility will be described with reference to FIG. 4.

### (Step S1-2)

A check-in process is performed between the information terminal 30 and the information management server 100. The processing unit 103 acquires address information of an information display terminal included in data of an accommodation facility including reservation information of a guest who has checked in. The processing unit 103 outputs the acquired address information of the information display terminal to the creation unit 110.

### (Step S2-2)

In the information management server 100, the generation unit 104 acquires check-in information from the communication unit 102 and acquires information for identifying an accommodation facility and information for identifying an accommodation schedule included in the acquired check-in information. The generation unit 104 generates accommodation-specific information that is unique information corresponding to the information for identifying the acquired accommodation facility and the information for identifying the accommodation schedule.

### (Step S3-2)

In the information management server 100, the generation unit 104 causes the storage unit 109 to store the generated accommodation-specific information.

### (Step S4-2)

In the information management server 100, the conversion unit 108 acquires the accommodation-specific information from the generation unit 104 and converts location information including the acquired accommodation-specific information into information code information.

### (Step S5-2)

In the information management server 100, the creation unit 110 acquires address information of the information display terminal output by the processing unit 103. The creation unit 110 acquires information code information from the conversion unit 108 and creates an information code notification which includes the acquired information code and in which the address information of the acquired information display terminal is designated as a destination.

### (Step S6-2)

In the information management server 100, the creation unit 110 outputs the created information code notification to the communication unit 102. The communication unit 102 transmits the information code notification output by the processing unit 103 to the information display terminal 20.

### (Step S7-2)

In the information display terminal 20, the communication unit 22 receives the information code notification transmitted by the information management server 100. The processing unit 23 acquires the information code notification from the communication unit 22 and acquires information code information included in the acquired information code notification. The processing unit 23 causes the display unit 27 to display the information code by processing the acquired information code information.

### (Step S8-2)

After checking in to the accommodation facility, the user U performs a manipulation of reading the information code displayed on the display unit 27 of the information display terminal 20. In the information terminal 30, the reading unit 36 reads the information code on the basis of the manipulation of the user U and acquires accommodation-specific information included in location information.

### (Step S9-2)

In the information terminal 30, the reading unit 36 causes the storage unit 39 to store the acquired accommodation-specific information.

### (Step S10-2)

In the information terminal 30, the manipulation unit 35 detects a manipulation in which the user U accesses the information management server 100 after checking in to the accommodation facility. The creation unit 40 acquires manipulation information detected by the manipulation unit 35 and acquires accommodation-specific information from the storage unit 39 on the basis of the acquired manipulation information. The creation unit 40 creates a second access request including the acquired accommodation-specific information.

### (Step S11-2)

In the information terminal 30, the creation unit 40 outputs the created second access request to the communication unit 32. The communication unit 32 transmits the second access request acquired from the creation unit 40 to the information management server 100.

### (Step S12-2)

In the information management server 100, the communication unit 102 receives the second access request transmitted by the information terminal 30. The processing unit 103 acquires a second access request from the communication unit 102 and acquires accommodation-specific information of the user U included in the acquired second access request. The processing unit 103 determines whether or not the acquired accommodation-specific information is stored in the storage unit 109.

### (Step S13-2)

In the information management server 100, the processing unit 103 allows access from the information terminal 30 when the accommodation-specific information of the user U is stored in the storage unit 109.

### (Step S14-2)

In the information management server 100, the creation unit 110 creates a second access response including the second provision information to be provided to the user U when the processing unit 103 allows access from the information terminal 30.

### (Step S15-2)

In the information management server 100, the creation unit 110 outputs the created second access response to the communication unit 102. The communication unit 102 transmits the second access response from the creation unit 110 to the information terminal 30.

### (Step S16-2)

In the information management server 100, the processing unit 103 does not allow access from the information terminal 30 when the accommodation-specific information of the user U is not stored in the storage unit 109.

### (Step S17-2)

In the information management server 100, the creation unit 110 creates a second access response including information indicating that access is not possible when the processing unit 103 does not allow access from the information terminal 30.

### (Step S18-2)

In the information management server 100, the creation unit 110 outputs the created second access response to the communication unit 102. The communication unit 102 transmits the second access response from the creation unit 110 to the information terminal 30.

### (Step S19-2)

In the information terminal 30, the communication unit 32 receives the second access response transmitted by the information management server 100. The processing unit 33 acquires the second access response from the communication unit 32. The processing unit 33 processes the second provision information to be provided to the user U or information indicating that access is not possible included in the acquired second access response and causes the display unit 37 to display the processed information.

Although the user U1, the user U2, the information terminal 30-1 used by the user U1, and the information terminal 30-2 used by the user U2 are shown in the above-described embodiment, the number of users U may be one or three or more.

Although the case where the accommodation reservation system 50 creates reservation-specific information has been described in the above-described embodiment, the present invention is not limited to this example. For example, after the accommodation reservation is completed, the accommodation reservation system 50 creates reservation information including information for identifying an accommodation facility, information for identifying a name of a guest, information for identifying an accommodation schedule, and the like and transmits the created reservation information to the information management server 100. The information management server 100 may be configured to receive the reservation information transmitted by the accommodation reservation system 50, create reservation-specific information on the basis of the received reservation information, store the created reservation-specific information in the storage unit 109, and transmit the created reservation-specific information to the information terminal 30-1.

Although the case where the accommodation reservation system 50 transmits the created reservation-specific information to the information management server 100 and the information terminal 30-1 has been described in the above-described embodiment, the present invention is not limited to this example. For example, the accommodation reservation system 50 may be configured to transmit the created reservation-specific information to the information management server 100 and the information terminal 30-2.

In this case, the information terminal 30-2 creates a first access request including reservation-specific information and transmits the created first access request to the information management server 100. The information management server 100 receives the first access request transmitted by the information terminal 30-2 and acquires the reservation-specific information included in the received first access request. The information management server 100 determines whether or not the acquired reservation-specific information is stored in the storage unit 109 and the information management server 100 allows an access request from the information terminal 30-1 when the acquired reservation-specific information is stored in the storage unit. According to the configuration as described above, the information management server 100 can allow access to the provision information from the information terminal 30-2 even if accommodation-specific information is not received from the information terminal 30-1.

Although the case where the reservation-specific information includes the accommodation facility, the name of the guest, the accommodation schedule, and the like has been described in the above-described embodiment, a reservation number, a party name set at the time of the reservation, and the like may be further included.

Although the case where the accommodation-specific information is the unique information corresponding to the information for identifying the accommodation facility and the information for identifying the accommodation schedule has been described in the above-described embodiment, the accommodation-specific information may be further unique information corresponding to information for identifying a guest and information for identifying a guest room where the guest stays.

Although the case where the information management server 100 generates accommodation-specific information and converts location information including the generated accommodation-specific information into an information code has been described in the above-described embodiment, the present invention is not limited to this example. For example, the location information may further include information for identifying a location of the second provision information to be provided to the user U. An example of the information for identifying the location of the second provision information provided to the user U is a uniform resource locator (URL).

According to the configuration as described above, when the user U performs a manipulation of reading the information code displayed on the display unit 27 of the information display terminal 20 after checking in to the accommodation facility, the reading unit 36 can read the information code on the basis of the manipulation of the user U and acquire accommodation-specific information and the information for identifying a location of second provision information. For this reason, the information terminal 30 can perform access on the basis of the acquired information for identifying the location of the second provision information.

According to the present embodiment, the information management system 1 manages provision information to be displayed on the information display terminal 20 installed in an accommodation facility. The information management system 1 includes the generation unit 104 configured to generate accommodation-specific information that is unique information corresponding to the accommodation facility and an accommodation schedule of the accommodation facility; the conversion unit 108 configured to convert location information including at least the accommodation-specific information into an information code; and the processing unit 103 configured to allow access to the provision information from a first information terminal (the information terminal 30-1 in the present embodiment) by receiving the accommodation-specific information from the first information terminal reading the information code displayed on the information display terminal 20 after check-in of accommodation in the accommodation schedule of the accommodation facility.

According to the configuration as described above, because the information management system 1 can allow access to the provision information from the first information terminal by receiving the accommodation-specific information from the first information terminal reading the information code displayed on the information display terminal 20 after check-in of accommodation in the accommodation schedule of the accommodation facility, it is possible to minimize the confirmation to determine whether or not to provide information in accordance with an information provision timing such as after check-in of accommodation in the accommodation schedule for the accommodation facility.

In the information management system 1, the location information further includes information for identifying a location of the provision information, and the processing unit 103 allows the access to the provision information from the first information terminal by receiving the accommodation-specific information from the first information terminal when the first information terminal reading the information code has accessed the provision information.

According to the configuration as described above, because the information management system 1 can allow the access to the provision information by receiving the accommodation-specific information from the first information terminal at the time of access of information for identifying the location of the provision information from the first information terminal reading the information code, it is possible to simplify the determination of whether or not to provide information.

In the information management system 1, the processing unit 103 allows the access to the provision information from a second information terminal (the information terminal 30-2 in the embodiment) even if the accommodation-specific information is not received from the first information terminal by receiving reservation-specific information, which is information generated in accordance with an accommodation reservation in an accommodation schedule of the accommodation facility, from the second information terminal.

According to the configuration as described above, the information management system 1 can allow access to the provision information by receiving the reservation-specific information, which is the information generated in accordance with the accommodation reservation in the accommodation schedule of the accommodation facility, from the second information terminal.

In the information management system 1, the information display terminal 20 displays the accommodation-specific information for the first time after the check-in and the reservation-specific information is generated before the check-in.

According to the configuration as described above, the information management system 1 can allow access according to the accommodation-specific information after the check-in and can allow access according to the reservation-specific information before the check-in.

In the information management system 1, the first information terminal is the same as the second information terminal.

According to the configuration as described above, the information management system 1 can allow access to the provision information by receiving the reservation-specific information, which is the information generated in accordance with the accommodation reservation in the accommodation schedule of the accommodation facility, from the first information terminal.

In the information management system 1, provision information allowed to be accessed on the basis of the accommodation-specific information is different from provision information allowed to be accessed on the basis of the reservation-specific information.

According to the configuration as described above, the information management system 1 can provide different information before check-in and after check-in.

In the information management system 1, the generation unit 104 further generates accommodation-specific information corresponding to a guest.

In the information management system 1, the generation unit 104 further generates accommodation-specific information corresponding to identification information of a guest room where a guest stays.

According to the present embodiment, the information management system 1 manages provision information to be displayed on an information display terminal installed in an accommodation facility. The information management system 1 includes the processing unit 103 configured to allow access to the provision information from a first information terminal (the information terminal 30-1 in the embodiment) by receiving reservation-specific information that is information generated in accordance with an accommodation reservation of the accommodation facility from the first information terminal; the generation unit 104 configured to generate accommodation-specific information that is unique information corresponding to the accommodation facility and an accommodation schedule of the accommodation facility; and the conversion unit 108 configured to convert information including at least the accommodation-specific information into an information code. The processing unit 103 allows access to the provision information from a second information terminal (the information terminal 30-2 in the embodiment) even if the reservation-specific information is not received from the first information terminal by receiving the accommodation-specific information from the second information terminal reading the information code displayed on the information display terminal after check-in of a guest for the accommodation facility.

According to the configuration as described above, because the information management system 1 can allow access to the provision information by receiving the reservation-specific information, which is the information generated in accordance with the accommodation reservation in the accommodation schedule of the accommodation facility, from the first information terminal and can allow access to the provision information from the second information terminal by receiving the accommodation-specific information from the second information terminal reading the information code displayed on the information display terminal 20 after check-in of the accommodation in the accommodation schedule of the accommodation facility, it is possible to minimize the confirmation to determine whether or not to provide information in accordance with an information provision timing such as before or after check-in of accommodation in the accommodation schedule for the accommodation facility.

In the information management system 1, the information display terminal displays the accommodation-specific information for the first time after the check-in and the reservation-specific information is generated before the check-in.

According to the configuration as described above, the information management system 1 can allow access according to the accommodation-specific information after the check-in and can allow access according to the reservation-specific information before the check-in.

In the information management system 1, the first information terminal is the same as the second information terminal.

According to the configuration as described above, the information management system 1 can allow access to the provision information by receiving the reservation-specific information, which is the information generated in accordance with the accommodation reservation in the accommodation schedule of the accommodation facility, from the first information terminal.

Although embodiments of the present invention have been described above with reference to the drawings, specific configurations are not limited to the embodiments and a change in design and the like may also be included without departing from the scope or spirit of the present invention.

For example, a computer program for implementing the function of each device described above may be recorded on a computer-readable recording medium and the program stored in the recording medium may be read and executed by a computer system. Also, the “computer system” used here may include an operating system (OS) or hardware such as peripheral devices.

Moreover, the “computer-readable recording medium” refers to a flexible disk, a magneto-optical disc, a read-only memory (ROM), a writable nonvolatile memory such as a flash memory, a portable medium such as a digital versatile disc (DVD), or a storage device such as a hard disk embedded in the computer system.

Furthermore, the “computer-readable recording medium” is assumed to include a computer-readable recording medium for holding the program for a certain time period as in a volatile memory (for example, a dynamic random-access memory (DRAM)) inside the computer system including a server and a client when the program is transmitted via a network such as the Internet or a communication circuit such as a telephone circuit.

Also, the above-described program may be transmitted from a computer system storing the program in a storage device or the like via a transmission medium or transmitted to another computer system by transmission waves in a transmission medium. Here, the “transmission medium” for transmitting the program refers to a medium having a function of transmitting information as in a network (a communication network) such as the Internet or a communication circuit (a communication line) such as a telephone circuit.

Also, the above-described program may be a program for implementing some of the above-described functions. Furthermore, the above-described program may be a program capable of implementing the above-described function in combination with a program already recorded on the computer system, i.e., a so-called differential file (differential program).

### REFERENCE SIGNS LIST

1 Information management system
20 Information display terminal
22 Communication unit
23 Processing unit
27 Display unit
29 Storage unit
30, 30-1, 30-2 Information terminal
32 Communication unit
33 Processing unit
35 Manipulation unit
36 Reading unit
37 Display unit
29 Storage unit
40 Creation unit
50 Accommodation reservation system
52 Communication unit
53 Processing unit
59 Storage unit
60 Creation unit
100 Information management server
102 Communication unit
103 Processing unit
104 Generation unit
108 Conversion unit
109 Storage unit
110 Creation unit

What is claimed is:

1. An information management system for managing provision information to be displayed on an information display terminal installed in an accommodation facility, the information management system comprising:
a generation unit configured to generate accommodation-specific information that is unique information corresponding to the accommodation facility and an accommodation schedule of the accommodation facility;
a conversion unit configured to convert location information including at least the accommodation-specific information into an information code; and
a processing unit configured to allow a first information terminal to have an access to the provision information by receiving the accommodation-specific information from the first information terminal reading the information code displayed on the information display terminal after check-in of accommodation in the accommodation schedule of the accommodation facility.

2. The information management system according to claim 1,
wherein the location information further includes identifying information for identifying a location of the provision information, and
wherein the processing unit allows the first information terminal to have the access to the provision information by receiving the accommodation-specific information from the first information terminal when the first information terminal reading the information code has accessed the provision information.

3. The information management system according to claim 1, wherein the processing unit allows a second information terminal to have the access to the provision information even if the accommodation-specific information is not received from the first information terminal by receiving reservation-specific information, which is information generated in accordance with an accommodation reservation in an accommodation schedule of the accommodation facility, from the second information terminal.

4. The information management system according to claim 3, wherein the information display terminal displays the accommodation-specific information for the first time after the check-in and the reservation-specific information is generated before the check-in.

5. The information management system according to claim 3, wherein the first information terminal is the same as the second information terminal.

6. The information management system according to claim 3, wherein provision information allowed to be accessed on the basis of the accommodation-specific information is different from provision information allowed to be accessed on the basis of the reservation-specific information.

7. The information management system according to claim 1, wherein the generation unit further generates accommodation-specific information corresponding to a guest.

8. The information management system according to claim 1, wherein the generation unit further generates accommodation-specific information corresponding to identification information of a guest room where a guest stays.

9. An information management system for managing provision information to be displayed on an information display terminal installed in an accommodation facility, the information management system comprising:
a processing unit configured to allow a first information terminal to have an access to the provision information by receiving reservation-specific information that is information generated in accordance with an accommodation reservation of the accommodation facility from the first information terminal;
a generation unit configured to generate accommodation-specific information that is unique information corresponding to the accommodation facility and an accommodation schedule of the accommodation facility; and
a conversion unit configured to convert information including at least the accommodation-specific information into an information code,
wherein the processing unit is configured to allow a second information terminal to have an access to the provision information even if the reservation-specific information is not received from the first information terminal by receiving the accommodation-specific information from the second information terminal reading the information code displayed on the information display terminal after check-in of a guest for the accommodation facility.

10. The information management system according to claim 9, wherein the information display terminal displays the accommodation-specific information for the first time after the check-in and the reservation-specific information is generated before the check-in.

11. The information management system according to claim 9, wherein the first information terminal is the same as the second information terminal.

12. An information management method of managing provision information to be displayed on an information display terminal installed in an accommodation facility, the information management method comprising:
generating accommodation-specific information that is unique information corresponding to the accommodation facility and an accommodation schedule of the accommodation facility;
converting location information including at least the accommodation-specific information into an information code; and
allowing a first information terminal to have an access to the provision information by receiving the accommodation-specific information from the first information terminal reading the information code displayed on the information display terminal after check-in of accommodation in the accommodation schedule of the accommodation facility.

13. An information management method of managing provision information to be displayed on an information display terminal installed in an accommodation facility, the information management method comprising:
allowing a first information terminal to have an access to the provision information by receiving reservation-specific information that is information generated in accordance with an accommodation reservation of the accommodation facility from the first information terminal;
generating accommodation-specific information that is unique information corresponding to the accommodation facility and an accommodation schedule of the accommodation facility;
converting information including at least the accommodation-specific information into an information code; and
allowing a second information terminal to have an access to the provision information even if the reservation-specific information is not received from the second information terminal by receiving the accommodation-specific information from the second information terminal reading the information code displayed on the information display terminal after check-in of a guest for the accommodation facility.
